(19) United States
(12) Patent Application Publication
(10) Pub. No.: US 2003/0208435 A1
(43) Pub. Date: Nov. 6, 2003

(54) In an on-line system and method for processing requests-for-proposals, a system and method for assembling a proposal in response to an RFP

(76) Inventor: Enrique Posner, New York, NY (US)

Correspondence Address: SOFER & HAROUN, L.L.P., Suite 1921, 342 Madison Avenue, New York, NY, 10173, US

(21) Appl. No.: 09/754,827

(22) Filed: Jan. 4, 2001

Related U.S. Application Data
(60) Provisional application No. 60/211,719, filed on Jun. 15, 2000.

(51) Int. Cl. G06F 17/60

(52) U.S. Cl. 705/37

(57) ABSTRACT

The present invention, in accordance with one embodiment, provides a system and method for creating, managing and tracking Requests-For-Proposals in an on-line environment. The on-line system comprises a vendor terminal and a buyer terminal. A processor is coupled to the vendor terminal and to the buyer terminal via the Internet. The processor comprises a template module configured to provide a proposal template to a user of the vendor terminal for creating a proposal in response to a request-for-proposal created by a user of the buyer terminal.

This application claims the benefit of priority from the provisional application serail No. 60/211,719 filed on Jun. 6, 2000 entitled “AN ON-LINE SYSTEM AND METHOD FOR PROCESSING REQUESTS FOR PROPOSALS”, which is incorporated by reference herein. This application also relates to Applicant's co-pending applications; identified as Attorney Docket Numbers 878-006, 878-008, 878-009 and 878-011, each of which are incorporated by reference herein.

### FIELD OF THE INVENTION

This invention relates to an on-line system and method for processing orders for highly specialized goods by way of a system and method that processes and manages data corresponding to RFP's (“requests-for-proposal”). More specifically, this invention relates to a system and method for a vendor to assemble a proposal in response to an RFP.

### BACKGROUND

Many goods which are purchased by a large industrial entity (e.g.—utility and/or energy companies) may be purchased over-the-counter. These type of goods are typically employed by the industrial facility for the maintenance, repair and operation of the facility, and are often referred to as “MRO” products. Since these products are relatively common, they may be purchased from a catalog. Alternatively, they may be purchased on-line in the typical fashion, whereby a user visits the website of a vendor and orders the product described on the website.

However, there are many goods which can not be purchased over-the-counter by a large industrial entity. Highly engineered goods typically fall into this category, as they are very often required by an industrial entity but can not be purchased in the typical on-line fashion described above. Highly engineered goods, by definition, must meet an industrial entity's specific, and often unique, engineering requirements. Thus, they can not be purchased from a catalog or on-line.

Instead, highly engineered goods are typically procured by an industrial entity by creating a request-for-proposal (referred to hereinafter as an “RFP”). The RFP describes the unique engineering specifications that are required to be incorporated in the product. The RFP is then supplied to vendors that are deemed capable of manufacturing the product in accordance with the required engineering specifications. The vendors' proposals are then submitted to the industrial entity for its consideration.

While the above-described RFP system is very commonly employed by industrial entities, there is currently no system or method which provides an optimal workflow and collaboration capabilities in the creation, management and tracking of RFP's in an on-line environment. Thus, there exists a need for such a system and method.

### SUMMARY OF THE INVENTION

The present invention, in accordance with one embodiment, provides a system and method for creating, managing and tracking RFP's in an on-line environment. Although not limited thereto, the system and method of the present invention is particularly well-suited to utility and energy companies, which often require highly engineered goods made to uniquely required specifications. For the purposes of this application, the entity making an RFP is referred to hereinafter as a “purchaser” and the entity responding to the RFP is referred to hereinafter as “vendor”, although the present invention is not intended to be limited in scope to any particular type of purchaser, nor to any particular type of good.

In a preferred embodiment, the system comprises a network of at least one purchaser terminal for entering request data and a network of at least one vendor terminal for entering proposal data. The request data may include, but is not limited to, the name and type of product desired, the unique engineering specifications that the product must meet, as well as scheduling terms, payment terms etc. The proposal data may include, but is not limited to, the name and type of product which is available, an explanation of how the available product meets the specified engineering requirements, the price and availability of the product, etc.

The system also comprises a processor having a web server, which is configured to maintain an addressable web site for providing interfaces to users of the purchaser and vendor terminals. The processor also comprises a purchaser team builder module, which is configured to receive and process request data from one or more of the purchaser terminals and to provide a workflow that enables the users of the one or more purchaser terminals to collaborate in the creation of an RFP. Similarly, the processor also comprises a vendor team builder module, which is configured to receive and process proposal data from one or more of the vendor terminals and to provide a workflow that enables the users of the one or more purchaser terminals to collaborate in the creation of a proposal in response to the RFP.

The processor may also comprise a broadcast module, which is configured to broadcast the requested data to a desired number of vendors. The broadcast module may also comprise a broadcast rules module and a broadcast population module. In a preferred embodiment, the broadcast rules module comprises the requirements that must be met by a particular vendor in order to receive the broadcast of an RFP. The broadcast population module, on the other hand, is configured to store data corresponding to all of the vendors that may be used.

The processor may also comprise a proposal analysis module. The proposal analysis module is configured to receive and process proposals that are received from various vendors and, advantageously, to generate a proposal tabulation that identifies the vendor which is the most suitable to receive the order. The processor may also comprise a negotiation module, which is configured to enable the purchaser and vendor to communicate directly with each other via e-mail in order to negotiate the terms of the order.

In a preferred embodiment, the processor also comprises an analytics module. The analytics module is configured to track an order by ascertaining its progress at various stages of production. The analytic data generated by the analytics module may advantageously be mined for various reasons. For instance, data corresponding to a particular vendor's on-time delivery performance may be processed for use by the broadcast module in order to determine whether the vendor will receive future RFP's via broadcast.

In a preferred embodiment of the present invention, a system and method is provided allowing a buyer to create and broadcast a RFP, where by a vendor is notified of a buyers RFP. Upon receipt of the RFP, the vendor decides to either tender a response or to ignore the RFP. The decision of the vendor is reported to the buyer through the system. Assuming the vendor decides to tender a response, the vendor then proceeds in creating a proposal team using the vendor team builder module. The vendor proposal team them prepares a response to the RFP, which is stored in the system. The RFP is then submitted to the project manager, legal team and marketing lead for editing. Upon the completion of the editing, the changes are entered and the system modifies the saved proposal in accordance with the new information. After the editing process is completed the system then delivers to the buyer the response to their RFP, for their review and decision to accept or reject.

### BRIEF DESCRIPTION OF THE DRAWINGS

The subject matter regarded as the invention is particularly pointed out and distinctly claimed in the concluding portion of the specification. The invention, however, both as to organization and method of operation, together with features, objects, and advantages thereof may best be understood by reference to the following detailed description when read with the accompanying drawings in which:

FIG. 1 is a diagram that illustrates the salient features of an on-line RFP management system, in accordance with one embodiment of the present invention;

FIG. 2 is a chart that illustrates the steps performed during the operation of the system for vendor response to RFPs, in accordance with one embodiment of the invention;

FIG. 3 is a flowchart that illustrates the steps that are performed in order for a vendor team builder module to create a proposal team, in accordance with one embodiment of the invention;

FIG. 4 is a flowchart that illustrates the steps that are performed in order for the vendor to receive the RFP and to respond, in accordance with one embodiment of the invention;

FIG. 5 is a flowchart that illustrates the steps that are performed in order for the vendor to create a proposal, in accordance with one embodiment of the invention;

FIG. 6 is a flowchart that illustrates the steps that are performed in order for the vendor to review the proposal, in accordance with one embodiment of the invention;

FIG. 7 is a flowchart that illustrates the steps that are performed in order for the vendor to send the proposal to the buyer, in accordance with one embodiment of the invention;

### DETAILED DESCRIPTION OF THE INVENTION

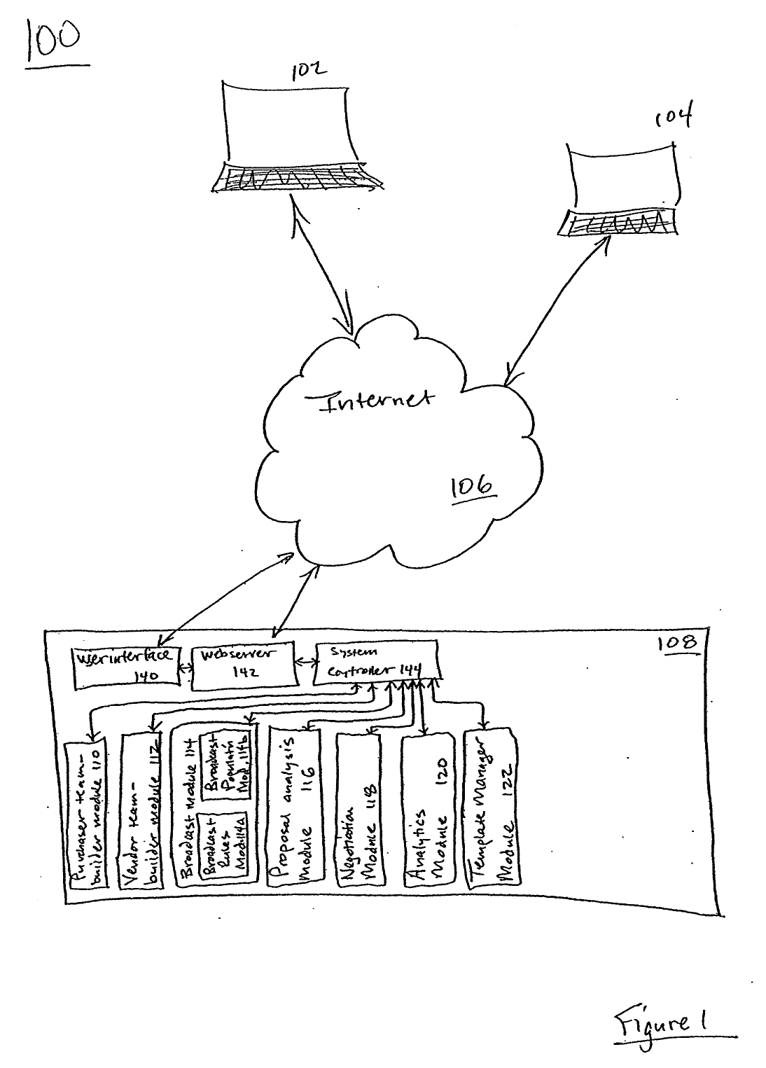

In accordance with one embodiment, the present invention is directed to a system and method for creating, managing and tracking RFP's in an on-line environment. The salient features of the present invention according to one embodiment, are shown in FIG. 1. Although not limited thereto, the present invention is advantageously employed by utility and energy companies.

FIG. 1 illustrates a communications system 100, in accordance with one embodiment of the present invention. In the embodiment shown, vendor terminal 102 and purchaser terminal 104, such as personal computers, hand-held devices or the like, are coupled to Internet 106. Also coupled to Internet 106 is processor 108.

Processor 108 comprises web server 142 which is configured to maintain an addressable web site. Processor 108 also comprises viewer display interface 140 that provides an interface for users of the computer terminals to communicate with processor 108, as will be described further below. System controller 144 is coupled to web server 142, and controls the operation of processor 108. Processor 108 also comprises modules which perform various operations (although it is noted that these modules need not be discrete components but may instead be any combination of components, or software, which provide the desired functionality described below).

According to one embodiment of the invention, processor 108 comprises purchaser team builder module 110, which is configured to receive and process request data from one or more of the purchaser terminals. Purchaser team builder module 110 provides a workflow that enables the users of the one or more purchaser terminals to collaborate in the creation of an RFP.

Processor 108 also comprises vendor team builder module 112, which is configured to receive and process proposal data from one or more of the vendor terminals. Vendor team builder module 112 provides a workflow that enables the users of the one or more purchaser terminals to collaborate in the creation of a proposal in response to the purchaser's RFP.

Processor 108 may also comprise broadcast module 114, which is configured to broadcast the requested data to a desired number of vendors. Broadcast module 114 may also comprise a broadcast rules module 114a and a broadcast population module 114b. In a preferred embodiment, the broadcast rules module 114a comprises the requirements that must be met by a particular vendor in order to receive the broadcast of an RFP. The broadcast population module 114b, on the other hand, is configured to store data corresponding to all of the vendors that may be used.

Processor 108 may also comprise proposal analysis module 116. Proposal analysis module 116 is configured to receive and process proposals that are received from various vendors and, advantageously, to generate a proposal tabulation that identifies the vendor which is the most suitable to receive the order. Processor 108 may also comprise a negotiation module 118, which is configured to enable the purchaser and vendor to communicate directly with each other via e-mail in order to negotiate the terms of the order.

In a preferred embodiment, processor 108 also comprises analytics module 120. Analytics module 120 is configured to track an order by ascertaining its progress at various stages of production. The analytic data generated by analytics module 120 may advantageously be mined for various reasons. For instance, data corresponding to a particular vendor's on-time delivery performance may be processed for use by the broadcast module 114 in order to determine whether the vendor will receive future RFP's via broadcast.

Processor 108 may also comprise template manager module 122. Template manager module 122 is configured to enable a user to either create new templates (e.g.—engineering templates, legal templates, etc.) or to select from existing templates from a template library. The templates that are generated by template manager module 122 provide a predetermined format for storing data entered by users, thereby allowing efficient storage and evaluation of pertinent RFP data.

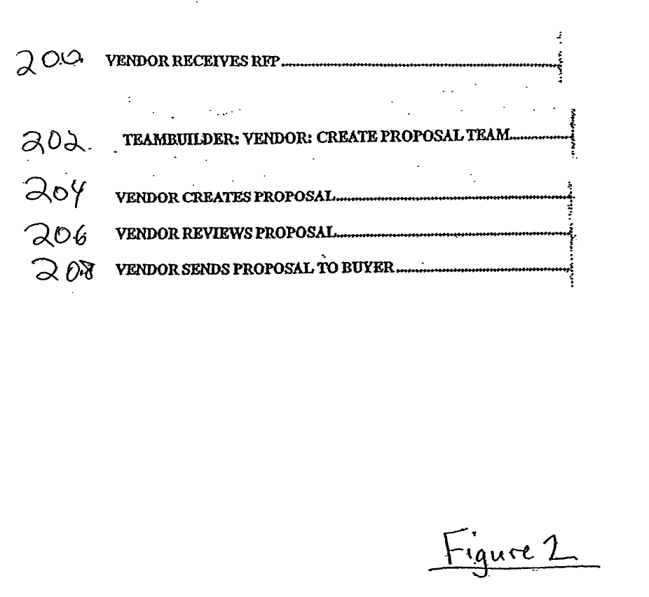

FIG. 2 is a flow chart that illustrates the steps that are performed by vendors when receiving RFPs during the operation of system 100, in accordance with one embodiment of the invention. It is noted that the steps that are illustrated in FIG. 2 are merely exemplary, and greater or fewer number of steps may be employed in order to accomplish the same functions as described herein. In addition, it is noted that, while some of these steps are listed in the order in which they are performed, this is not necessarily the case.

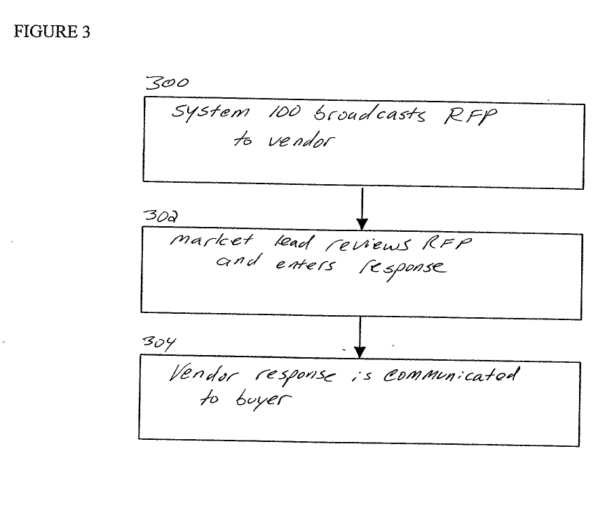

At step 200, the vendor receives the RFP and determines an appropriate response. FIG. 3, which is described in greater detail below, is a flowchart that illustrates the steps that are performed in order for the vendor to receive the RFP and to respond.

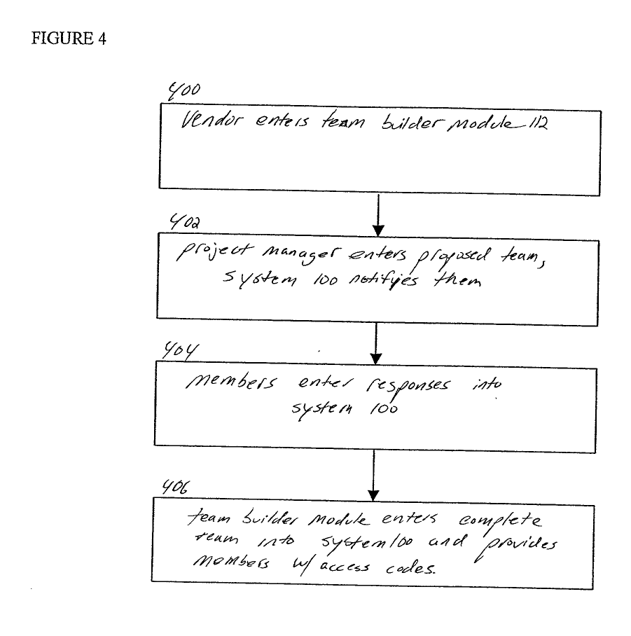

At step 202, a vendor, with the help of vendor team builder module 112 of processor 108 creates a proposal team. FIG. 4, which is described in greater detail below, is a flowchart that illustrates the steps that are performed in order for vendor to use vendor team builder module 110 to create a proposal team.

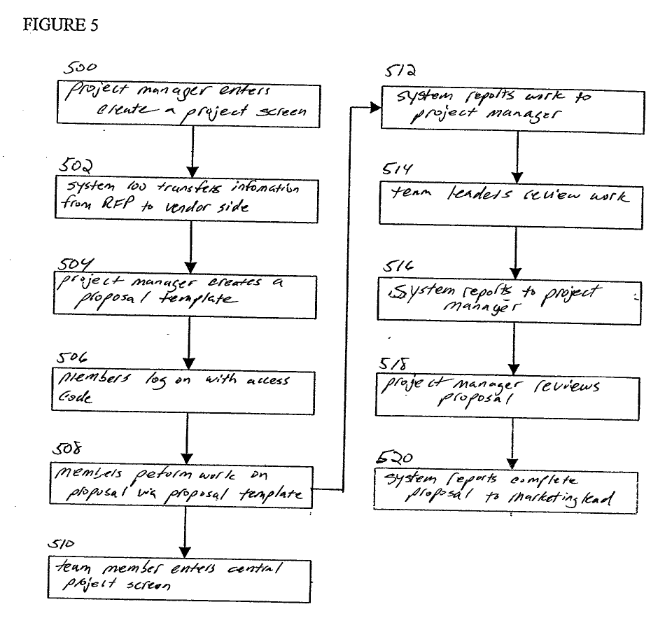

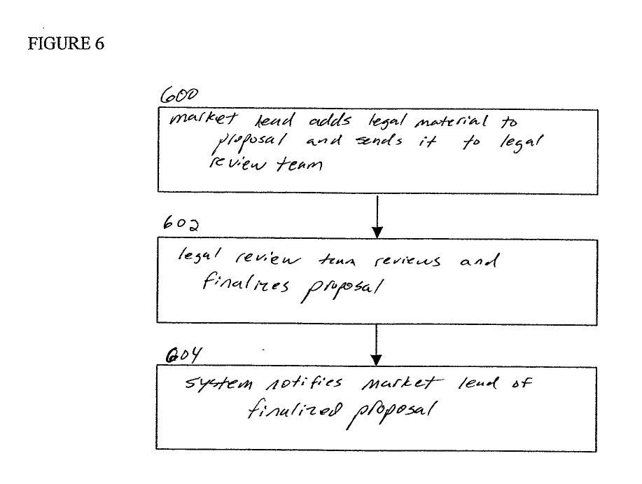

At step 204, the vendor creates a proposal in response to the RFP. FIG. 5, which is described in greater detail below, is a flowchart that illustrates the steps that are performed in order for the vendor to create a proposal. At step 206, the vendor reviews the proposal. FIG. 6, which is described in greater detail below, is a flowchart that illustrates the steps that are performed in order for the vendor to review the proposal.

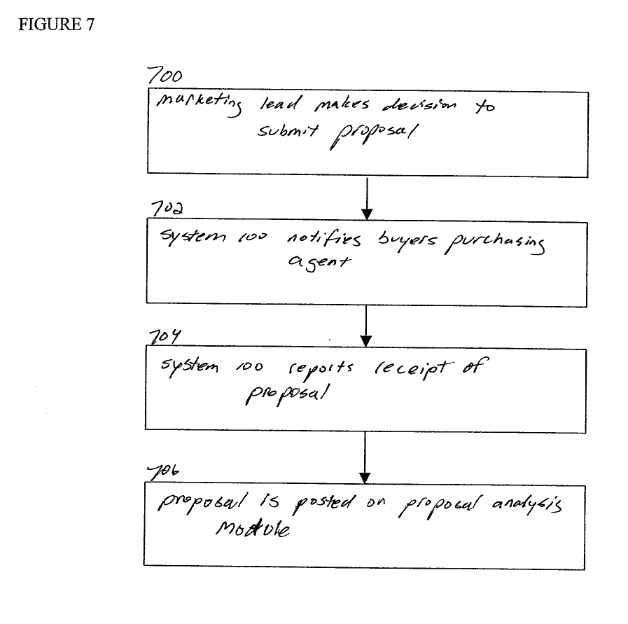

At step 208, the vendor sends the proposal to the purchaser. FIG. 7, which is described in greater detail below, is a flowchart that illustrates the steps that are performed in order for the vendor to send the proposal to the buyer.

In a preferred embodiment of the present invention system 100, a vendor refers to any entity within system 100 that is registered or selected to receive RFPs. One sample vendor type includes the various organizations that maintain and manufacture specialized engineered equipment such as industrial assembly machinery. When referring to vendors, several officials will be addressed separately that maintain different functions within the organization and thus perform different tasks within system 100. However, these position titles are used only to illustrate the manner in which various persons within an organization may collaborate in order to prepare a response to an RFP.

Marketing leads refer to the individuals in an organization that make the initial decision to act on and RFP. Department heads and project managers are the individuals who perform tasks such as assigning team members and team leaders, setting up project parameters, and making final decisions on proposals. Team leaders, refer to the member or members of a proposal team that organize the team members and wok load and communicate with the project manager and department heads. Team members are the workers at the vendor organization who prepare the proposal, performing tasks such as entering engineering specifications for the item to be sold. These vendor office positions are only intended as examples for the following discussion, and in no way are they intended to limit the scope of the present invention, All vendor entities and their officials are within the contemplation of this invention regardless of the vendor official's title.

Vendor Receives RFP

FIG. 3 is a flow diagram representing the steps that are performed, according to one embodiment of the present invention when a vendor receives an RFP from system 100. At step 300, system 100 broadcasts a buyer-produced RFP to various vendors within system 100 via RFP broadcast module 114. The means by which an RFP is created and broadcast is discussed in co-pending application identified as attorney docket number 878-006.

These vendors can be chosen by the buyer from a list, or in another embodiment they can be selected at random. In still another embodiment, the RFPs can be posted to all available vendors, or they can be targeted to certain industry groups organized by system 100 that may possess the desired item. After the RFP is broadcast by broadcast module 114 of system 100, the marketing lead from a vendor receives the RFP notice through e-mail, bulletin board posting or some other method of transmission.

At step 302, the marketing lead for the vendor reviews the RFP and enters a response into system 100. One of three responses can be made; “no response to be given”, “response to RFP forthcoming”, and “RFP under consideration”. If the vendor replies “no response to be given” the process of the vendor responding to the RFP is ended, and the vendor can await new RFPs from system 100. If the vendor replies “RFP under consideration”, then the marketing lead evaluates the RFP and possibly consults with others within the organization and decides whether or not to proceed with a proposal in response thereto. If the vendor replies “response to RFP forthcoming” then the vendor proceeds to the next phase of creating a proposal team. At step 304 system 100 notifies the buyer of the vendor response. Preferably, this process is ongoing, and the present invention contemplates that a periodic question/answer dialog is employed if the initial vendor response was “RFP under consideration.”

Vendor Creates Proposal Team

Assuming that the final vendor decides to create a proposal in response the RFP, a proposal project manager is selected and the vendor proceeds by creating a proposal team. A flow diagram of the process by which the vendor creates a proposal team is illustrated in FIG. 4. At step 400, the project manager employs the vendor team builder module 112 to select team members and team leaders from a list of available people stored in system 100. It is noted at any time the vendor organization wishes to add or delete team members or leaders to the saved list of potential team members, system 100 can be accessed by the proper individuals and the stored list of team member and leader candidates can be altered.

At step 402, system 100 e-mails or otherwise communicates to the selected team members and leader that they have been requested to join a proposal team. At step 404, selected individual's responses are entered into system 100, where the acceptance or denial of the invitation by the individual is reported to the project manager. This process is repeated until the appropriate number of individuals respond in the affirmative such that there are enough members to fill the project. The ability to accept/deny the assignment is predicated on the organizational structure of the vendor and may not be applicable to all organizations. The ability to facilitate this functionality is present in system 100 whether or not it is exercised by the vendor management.

At step 406, system 100 enters the team leaders and members into a proposal team list and notifies all other members of any additional persons added. The addition to this list is accompanied with an access code for the given project, the extent of clearance depending upon the members authority within the project (or organization). Although a proposal team is created after the RFP has been acknowledged and the decision to respond has already been made, it is possible that an organization that receives many RFPs may have standing proposal teams at all times. Additionally, the selection of team members and leaders is a dynamic process and system 100 will constantly monitor the team and add and subtract members as directed by the project manager, notifying all members of the changes.

Vendor Creates Proposal

In a preferred embodiment of the present invention, upon receipt and acceptance of an RFP from a potential buyer, the vendor begins the process of creating a proposal in response to the RFP. A flow chart of the proposal creation process according to one embodiment is illustrated in FIG. 5. At this point the vendor marketing lead selects a project manager for this proposal.

At step 500, the project manager accesses system 100 and enters the “create a project” screen of system 100 where the manager enters the relevant information about the proposal. At step 502, system 100 automatically uses data from the stored RFP to fill in the project information. For example, information concerning the engineering specifications contained in the RFP are automatically downloaded to the vendor side of system 100. This information is the same information as that entered by the buyer who created the RFP, the process of which is described in Applicant's co-pending application identified by the docket number 878-011.

At step 504, the project manager, creates a proposal in response to an RFP template with the aid of template manager module 122. After creating the proposal template 123, system 100 inserts all of the relevant information, including the RFP/proposal specification from step 502 and the project team (project manager, team leaders, team members, department heads and marketing leads) as constructed in steps 400-406 as described above, into proposal template 123.

When a team member decides to work on a proposal, he or she logs onto the client proposal screen of system 100. At step 506, system 100 verifies an access code entered by the member. At step 508, system 100 retrieves proposal template 123 where the member can work on the proposal. Any time the member attempts to alter any information on proposal template 123, the access code verifies that that particular member has the authority to do so.

It is noted that some proposals in response to RFPs are complex and may have several separate teams working on the proposal at once. In this case, system 100 may maintain a layered proposal template 123 which is sub-divided into smaller proposal templates 123.

In some cases, while working on a proposal, a team member may not have all of the information necessary to complete a given task. At step 510, the team member can enter the central proposal project screen link in system 100 to access additional information. The team member is given several options including but not limited to: linking to a bulletin board to view/communicate specific items regarding the proposal in question; linking to a question/answer section to view questions or notifications, as well as to post questions or link to private library (based on access) to view documents specific to the proposal.

Upon completion of the task at hand, the member logs off proposal template 123 and the work is stored. At step 512, the project manager is informed by system 100 via e-mail, bulletin board or some other communication of which member was working on the proposal and what section of the proposal they worked on.

At step 514, team leaders enter the proposal process screen of system 100 which is employed to access proposal template 123 and review the work done by the team members under their supervision. System 100 verifies if the team leaders have the appropriate access to review the work. If they disapprove of the work, they enter a disapprove command and system 100 notifies the appropriate team member to review the work submitted, thus returning to step 508. If the work is approved, system 100 proceeds to step 516, where it notifies the project manager that the particular team's work is completed.

At step 518, the project manager enters the proposal process section of system 100. From there the managers can access proposal template 123 and check the work of the various teams working on a proposal as submitted by their team leader in step 514. System 100 verifies that the proposal manager has the authority to review the work. If they disapprove, system 100 notifies the appropriate team leader of the problem and the process is repeated from step 514 (which may require that the process return to step 508, in the event that the error requires an individual team member to correct it). If the proposal manager approves, then at step 520, system 100 notifies the market lead that the proposal project is complete and the review process is initiated. At all times during the process of creating and editing the proposal, system 100 automatically saves the work performed in proposal template 123 by any member when they log off.

Vendor Reviews Proposal

In a preferred embodiment of the present invention, the market lead for a proposal receives the completed draft proposal from the project manager. Upon receipt, at step 600, the marketing lead enters proposal template 123 of system 100 and enters the necessary legal materials. Next, at step 602 the system sends a copy of the draft proposal with legal terms from proposal template 123 to the legal review department of the organization. System 100 verifies that the legal team and the market lead have authorization to view and edit the proposal. If the legal review team disapproves of the proposal, system 100 will send it back to the marketing lead to make the appropriate correction (this step may entail returning the draft proposal to the project manager, team leaders or team members depending upon who needs to correct the error). If the legal team approves the draft proposal then the proposal draft is deemed finalized. At step 604, the marketing lead is notified by system 100 that the finalized proposal is now ready for submission to the buyer, via system 100.

Vendor Sends Proposal to Buyer

In a preferred embodiment of the present invention, after the vendor creates a proposal in response to a buyer RFP, the vendor then submits proposal template 123 to the buyer via system 100. At step 700, after the marketing leads makes a final decision to send the proposal, the market lead selects the proposal that is “pending submission” and submits the proposal into system 100.

At step 702, system 100, notifies the buyer purchasing agent in charge of the RFP, and at step 704, system 100 notifies the vendor when the buyer receives the proposal. At step 706, the final proposal is placed on the buyer side of system 100 on proposal analysis module 116, where the various proposal received by a buyer in response to an RFP can be analyzed side by side.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. An on-line system comprising:
a vendor terminal;
a buyer terminal; and
a processor coupled to said vendor terminal and said buyer terminal via the Internet, said processor comprising a template module configured to provide a proposal template to a user of said vendor terminal for creating a proposal in response to a request-for-proposal created by said a user of said buyer terminal;

2. An on-line system as claimed in claim 1, wherein said processor further comprises a vendor team builder module configured to provide a vendor with a means to organize, create and manage a proposal team.

3. An on-line system as claimed in claim 1, wherein said processor further comprises a system controller module configured to regulate the functions of said processor, including the managing of stored data on said system.

4. An on-line system as claimed in claim 1, wherein said processor further comprises a user interface module and to the internet configured to provide said vendor and said buyer with a method to communicate with said system and with each other.

5. An on-line system as claimed in claim 1, wherein said processor further comprises a proposal analysis module of said system configured to provide a vendor proposal table to facilitate said buyer's decision as to which proposal to accept.

6. An on-line system as claimed in claim, wherein said processor further comprises a broadcast module of said system configured to broadcast said request-for-proposals created by said buyer to said vendors.

7. An on-line system as claimed in claim 1, wherein said proposal template is configured to automatically save any work performed on said proposal when any member of said proposal team logs off of said proposal template

8. An on-line system as claimed in claim 1, wherein said proposal template is configured to automatically report any work performed on said proposal stored on said proposal template to the appropriate team leader or manager of said proposal team.

9. An on-line system as claimed in claim 1, wherein said proposal template is configured to provide a security access means, to ensure that only authorized members of said proposal team operate on said proposal.

10. A method comprising the steps of:
at a vendor terminal, receiving a request-for-proposal from a buyer terminal via a processor which is coupled to said vendor terminal and said buyer terminal via the Internet;
said vendor creating a proposal team on a vendor team builder module of said processor; and
said vendor creating a proposal in response to said request-for-proposal, wherein said proposal is created on a proposal template maintained by a template manager module of said processor.

12. The method of creating a proposal as claimed in claim 11, further comprising the step of said vendor reviewing said proposal on said proposal template.

13. The method of creating a proposal as claimed in claim 11, further comprising the step of said vendor sending said proposal to said buyer that issued said request for proposal via said online system.

14. The method of creating a proposal as claimed in claim 11, where in said vendor communicates internally between members of said proposal team via on-line system 100

15. The method of creating a proposal as claimed in claim 11, where in said creating of said proposal includes the steps of creation of the proposal at a team member level, review of team member work by a team leader, review of a completed proposal by a project manager and review and submission of a finalized proposal by a marketing lead.
